(19) United States
(12) Patent Application Publication
(10) Pub. No.: US 2006/0062579 A1
(43) Pub. Date: Mar. 23, 2006

(54) Optical network for bi-directional wireless communication

(75) Inventors: Yong-Gyoo Kim, Seoul (KR); Seong-Taek Hwang, Pyeongtaek-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/202,505

(22) Filed: Aug. 12, 2005

(30) Foreign Application Priority Data
Sep. 17, 2004 (KR) 2004-74543

(51) Int. Cl. H04B 10/00

(52) U.S. Cl. 398/115

(57) ABSTRACT

An optical network for bi-directional wireless communication is disclosed. The optical network includes a remote antenna unit for converting a downlink optical signal into a downlink radio signal, transmitting the downlink radio signal wirelessly, and converting an uplink radio signal received wirelessly into an uplink optical signal. An optical line is used as a transmission medium of the downlink optical signal and the uplink optical signal. The optical network also includes a central base station including a circulator linked to the remote antenna unit through the optical line, so that the central base station outputs the downlink optical signal to the remote antenna unit through the circulator and detects the uplink optical signal inputted through the circulator.

### CLAIM OF PRIORITY

This application claims priority to an application entitled “Optical Network for Bi-directional Wireless Communication,” filed in the Korean Intellectual Property Office on Sep. 17, 2004 and assigned Serial No. 2004-74543, the contents of which are incorporated herein by reference.

### BACKGROUND OF THE INVENTION

1. Field of the Invention

The present invention relates to a wireless communication system, and more particularly to an optical network for bi-directional wireless communication.

2. Description of the Related Art

To support various types of multimedia data, wireless communication systems must provide wireless networks capable of stably providing a large quantity of service. In particular, for the transmission of mass storage data, optical networks (i.e., a radio-over-fiber (‘ROF’) obtained by combining a wireless communication system and an optical fiber) and radio highway network are being investigated.

An ROF-type optical network for wireless communication concentrates apparatuses distributed to a plurality of base stations to one central base station and replaces a complicated base station with a remote antenna unit including an optical transceiver and an antenna.

FIG. 1 is a block diagram showing a conventional ROF-type optical network 100 for wireless communication. The conventional optical network 100 includes a central base station 110, a remote antenna unit 130 for converting an optical signal into a radio signal or a radio signal into an optical signal, and downward and uplink optical lines 121 and 122 for linking the central base station 110 to the remote antenna unit 130. Generally, the downward and uplink optical lines 121 and 122 may use an optical fiber, etc.

The central base station 110 includes an optical transmitter 111 linked to the remote antenna unit 130 by the downlink optical line 121 and an optical receiver 112 linked to the remote antenna unit 130 by the uplink optical line 122. The optical transmitter 111 generates a data-modulated downlink optical signal and outputs the downlink optical signal to the remote antenna unit 130. The optical receiver 112 detects an uplink optical signal input through the uplink optical line 122.

The remote antenna unit 130 includes an optoelectric converter 131 for converting the downlink optical signal into a downlink radio signal, an electrooptic converter 132 for converting the uplink radio signal into an uplink optical signal and outputting the uplink optical signal to the central base station 110, a duplexer 133 and an antenna 134.

The antenna 134 sends the uplink radio signal to the electrooptic converter 132 through the duplexer 133 and wirelessly sends the downlink radio signal input through the duplexer 133 to each subscriber or an external of the remote antenna unit 130.

FIG. 2 is a block diagram showing a conventional ROF-type optical network 200 for wireless communication. The conventional optical network 200 includes a central base station 210, downward and uplink optical lines 221 and 222 and a remote antenna unit 230.

The central base station 210 includes an optical transmitter 211 for generating a downlink optical signal and an optical receiver 212 for detecting data from an uplink optical signal. The optical transmitter 211 is linked to the remote antenna unit 230 through the downlink optical line 221 and the optical receiver 212 is linked to the remote antenna unit 230 through the uplink optical line 222.

The remote antenna unit 230 includes an electro-absorption optical modulator 231 and an antenna 232. The remote antenna unit 230 converts a downlink optical signal input from the central base station 210 into a radio signal and sends the radio signal. The remote antenna unit 230 also converts a received radio signal into the uplink optical signal and outputs the uplink optical signal to the central base station 210.

The conventional optical networks discussed above link the central base station to the remote antenna unit using optical lines. One drawback of this arrangement, however, it the increased installation cost of the optical lines.

### SUMMARY OF THE INVENTION

One aspect of the present invention relates to an optical network for wireless communication capable of reducing maintenance and installation cost of an optical line.

One embodiment of the present invention is directed to an optical network for bi-directional wireless communication including a remote antenna unit for converting a downlink optical signal into a downlink radio signal, transmitting the downlink radio signal wirelessly, and converting an uplink radio signal received wirelessly into an uplink optical signal. The optical network also includes an optical line being a transmission medium of the downlink optical signal and the uplink optical signal, and a central base station including a circulator linked to the remote antenna unit through the optical line. The central base station outputs the downlink optical signal to the remote antenna unit through the circulator and detects the uplink optical signal inputted through the circulator.

### BRIEF DESCRIPTION OF THE DRAWINGS

The above and other aspects, features and embodiments of the present invention will be more apparent from the following detailed description taken in conjunction with the accompanying drawings, in which:

FIG. 1 is a block diagram showing a conventional ROF-type optical network for wireless communication;

FIG. 2 is a block diagram showing a conventional ROF-type optical network for wireless communication;

FIG. 3 is a block diagram showing an optical network for bi-directional wireless communication according to an embodiment of the present invention;

FIG. 4 is a spectrum of the downlink optical signal shown in FIG. 3;

FIG. 5 is a spectrum of the uplink optical signal 302 shown in FIG. 3;

FIG. 6 is a spectrum showing a central frequency of the downlink radio signal shown in FIG. 3; and

FIG. 7 is a spectrum for showing a central frequency of the uplink radio signal shown in FIG. 3.

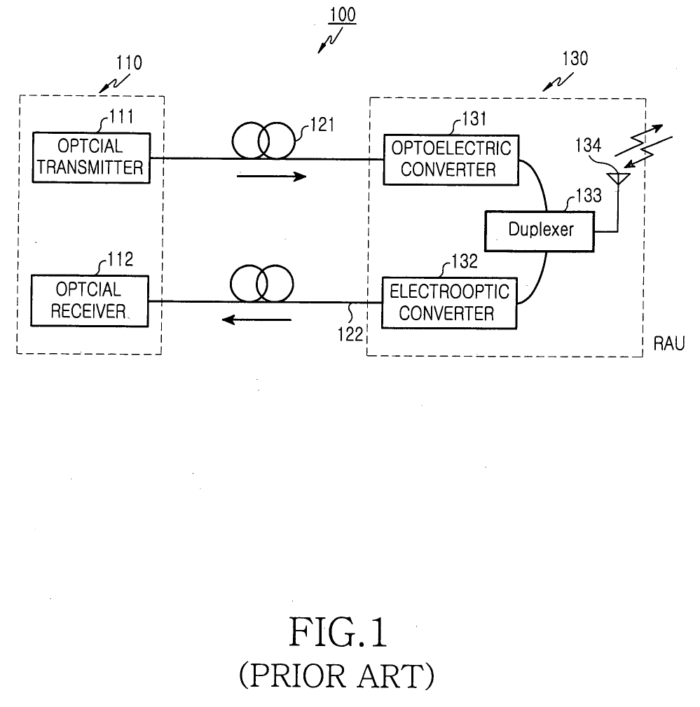

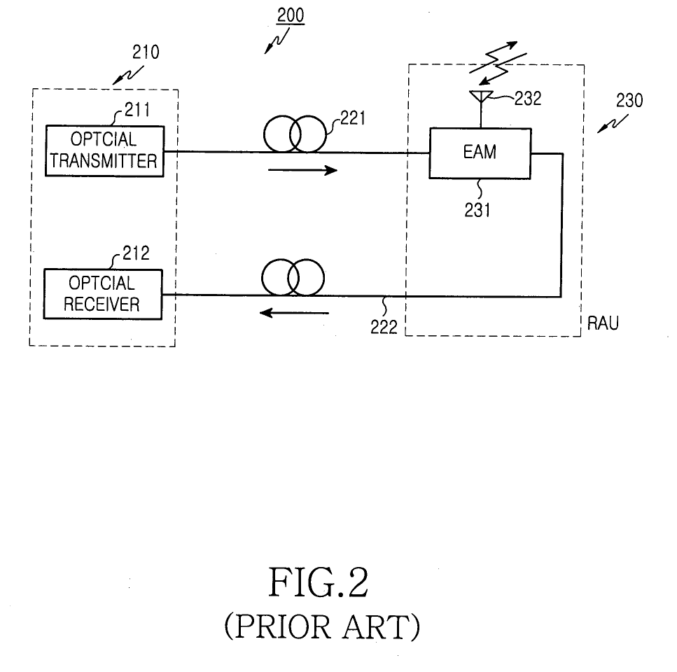

### DETAILED DESCRIPTION

Hereinafter, embodiments according to the present invention will be described with reference to the accompanying drawings. For the purposes of clarity and simplicity, a detailed description of known functions and configuration incorporated herein will be omitted as it may obscure the subject matter of the present invention.

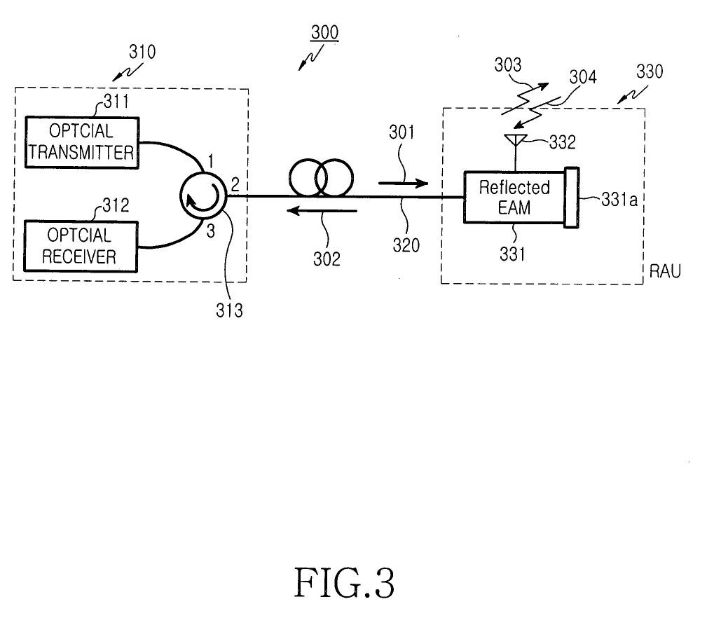

FIG. 3 is a block diagram showing an optical network 300 for bi-directional wireless communication according to an embodiment of the present invention. The optical network 300 includes a remote antenna unit 330, an optical line 320, and a central base station 310. The remote antenna unit 330 converts a downlink optical signal 301 into a downlink radio signal 303, transmits the downlink radio signal 303 wirelessly, and converts an uplink radio signal 304 received wirelessly into an uplink optical signal 302. The optical line 320 is a transmission medium of the downlink optical signal 301 and the uplink optical signal 302.

The central base station 310 includes an optical transmitter 311 for generating the downlink optical signal 301, an optical receiver 312 for detecting the uplink optical signal 302, and a circulator 313 linked to the remote antenna unit 330 through the optical line 320. The circulator 313 includes a first port connected to the optical transmitter 311, a second port connected to the remote antenna unit 330 and a third port connected to the optical receiver 312. The circulator 313 outputs the uplink optical signal 302 input through the second port to the third port and outputs the downlink optical signal 301 input through the first port to the remote antenna unit 330 through the second port.

The optical transmitter 311 generates the downlink optical signal 301 and outputs the downlink optical signal 301 to the first port of the circulator 313. The optical transmitter 311 may include, for example, a semiconductor laser. The optical receiver 312 detects the uplink optical signal 302 input from the third port of the circulator 313. The optical receiver 312 may use, for example, a photo diode.

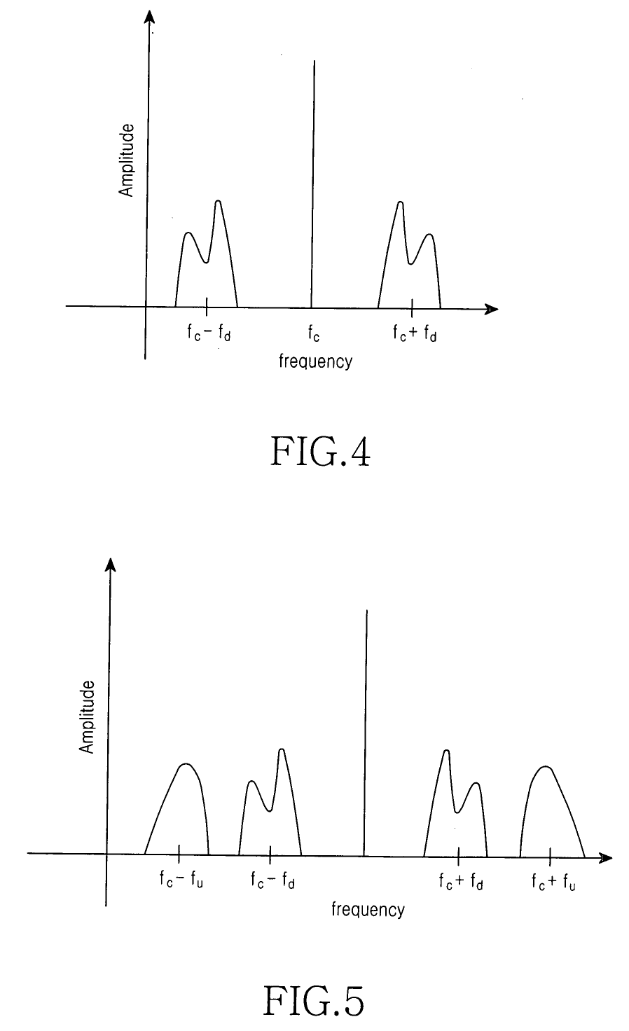

FIG. 4 is a spectrum of the downlink optical signal 301 shown in FIG. 3. FIG. 5 is a spectrum of the uplink optical signal 302 shown in FIG. 3. The f_{c} shown in FIG. 4 represents a common central frequency of the downlink optical signal 301 and the uplink optical signal 302, and the f_{d} represents a central frequency of the downlink radio signal 303. The fᵤ shown in FIG. 5 represents a central frequency of the uplink radio signal 304.

The remote antenna unit 330 includes an antenna 332 and an electro-absorption modulator 331. The antenna 332 receives the uplink radio signal 304 from the air, sends the uplink radio signal 304 to the electro-absorption modulator 331, and sends the downlink radio signal 303 input from the electro-absorption modulator 331 to subscribers.

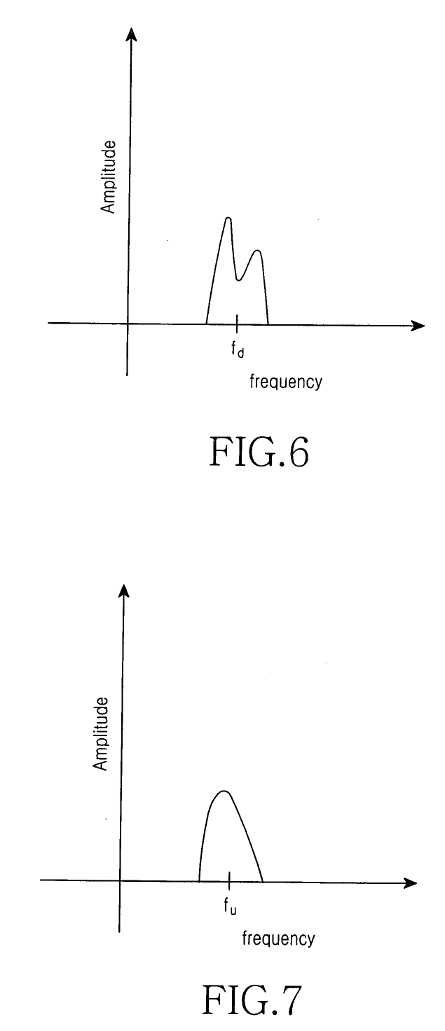

The electro-absorption modulator 331 converts the downlink optical signal 301 into the downlink radio signal 303. The electro-absorption modulator 331 also converts the uplink radio signal 304 received in the antenna 332 into the uplink optical signal 302 and outputs the converted uplink optical signal 302 to the central base station 310 through the optical line 320. FIG. 6 is a spectrum showing the central frequency of the downlink radio signal 303 converted by the electro-absorption modulator 33.1 FIG. 7 is a spectrum showing the central frequency of the uplink radio signal 304 received in the antenna 332.

The electro-absorption modulator 331 includes a high reflection layer 331a coated on a second surface opposed to a first surface linked to the central base station 310 through the optical line 320.

The electro-absorption modulator has a high reflection layer coated on a first surface opposed to a second surface linked to the central base station, so that the central base station can be linked to the electro-absorption modulator through a single optical line. Accordingly, this configuration of an optical network saves installation and maintenance cost of the optical line.

Although embodiments of the present invention has been described for illustrative purposes, those skilled in the art will appreciate that various modifications, additions and substitutions are possible, without departing from the scope and spirit of the invention as disclosed in the accompanying claims, including the full scope of equivalents thereof.

What is claimed is:

1. An optical network for bi-directional wireless communication, comprising:
a remote antenna unit arranged to convert a downlink optical signal into a downlink radio signal, transmit the downlink radio signal wirelessly, and convert an uplink radio signal received wirelessly into an uplink optical signal;
one optical line that can be used as a transmission medium for both the downlink optical signal and the uplink optical signal; and
a central base station including a circulator linked to the remote antenna unit through the optical line, wherein the central base station outputs the downlink optical signal to the remote antenna unit through the circulator and detects the uplink optical signal input through the circulator.

2. The optical network for bi-directional wireless communication as claimed in claim 1, wherein the remote antenna unit comprises:
an antenna arranged to receive the uplink radio signal and sending the downlink radio signal; and
an electro-absorption modulator arranged to convert the uplink radio signal received through the antenna into the uplink optical signal, convert the downlink optical signal input through the circulator into the downlink radio signal, output the downlink radio signal to the antenna.

3. The optical network for bi-directional wireless communication as claimed in claim 2, wherein the electro-absorption modulator includes a first surface linked to the central base station through the optical line and a second surface on which a high reflection layer is coated.

4. The optical network for bi-directional wireless communication as claimed in claim 1, wherein the central base station comprises:
an optical transmitter arranged to generate the downlink optical signal and output the downlink optical signal to a first port of the circulator; and
an optical receiver being connected to a third port of the circulator, arranged to detect the uplink optical signal output to the third port of the circulator through a second port of the circulator connected to the optical line.

5. The optical network for bi-directional wireless communication as claimed in claim 4, wherein the optical transmitter includes a semiconductor laser or a semiconductor optical amplifier.

6. The optical network for bi-directional wireless communication as claimed in claim 4, wherein the optical receiver includes a photo diode.

7. The optical network for bi-directional wireless communication as claimed in claim 1, wherein the optical line includes an optical fiber.

8. A device for an optical, bi-directional wireless communication network comprising:
a remote antenna unit arranged to convert a downlink optical signal into a downlink radio signal, transmit the downlink radio signal, and convert an uplink radio signal received into an uplink optical signal;
at least one optical line that can be used as a transmission medium for both the downlink optical signal and the uplink optical signal; and
an interface to a central base station.

9. The device as claimed in claim 8, wherein the remote antenna unit includes:
an antenna arranged to receive the uplink radio signal and sending the downlink radio signal; and
an electro-absorption modulator arranged to convert the uplink radio signal received through the antenna into the uplink optical signal, convert the downlink optical signal input through the interface into the downlink radio signal, output the downlink radio signal to the antenna.

10. The device as claimed in claim 9, wherein the electro-absorption modulator includes a first surface linked to the central base station through the optical line and a second surface on which a high reflection layer is coated.

11. The optical network for bi-directional wireless communication as claimed in claim 8, wherein the optical line includes an optical fiber.

12. an electro-absorption modulator comprising:
a converter arranged to convert a downlink optical signal into a downlink radio signal, an uplink radio signal into an uplink optical signal, and outputs the converted uplink optical signal; and
an interface to a central base station, the interface including a first surface that is opposed to a second surface and a reflection layer that is coated on the second surface.
